(19) United States
(12) Patent Application Publication
(10) Pub. No.: US 2005/0096206 A1
(43) Pub. Date: May 5, 2005

(54) Apparatus and method for folding airbags

(76) Inventors: Claudio Spinozzi, (US); Peter Heinz Dietz, (US); Ursula Lamberti, (US)

Correspondence Address: SCOTT A. MCBAIN;DELPHI TECHNOLOGIES, INC., P.O. Box 5052, Mail Code: 480-410-202, Troy, MI, 48007-5052, US

(21) Appl. No.: 10/928,742

(22) Filed: Aug. 27, 2004

(30) Foreign Application Priority Data
Sep. 15, 2003 (EP) 03020894.6

(51) Int. Cl. B60R 21/16

(52) U.S. Cl. 493/457

(57) ABSTRACT

The invention relates to an apparatus for folding airbags for motor vehicles having a folding chamber which tapers, starting at an entry region for an at least partly spread out airbag to be folded, in the direction of an exit region for the folded airbag and which includes inner sides which are mutually oppositely disposed in a configuration of use and which are each formed by a rib structure, the ribs of which form an exit nozzle which determines the airbag folding for the airbag which is moved through the folding chamber in the exit region of the folding chamber. The invention also relates to a method for folding airbags for motor vehicles.

This application claims priority to European Patent Application No. 03020894.6 filed Sep. 15, 2004.

### TECHNICAL FIELD

The invention relates to an apparatus and to a method for folding airbags for motor vehicles.

### BACKGROUND OF THE INVENTION

The folding of airbags and the further handling of the folded airbags is in practice frequently time consuming, complicated and expensive. For example, in the manufacture of roof rail roof airbags, which are also designated as RRABs, the airbag is first moved into a so-called Z-fold in a first apparatus, then heated to a temperature of, for example, approximately 130° and then cooled down again in a cooling plant in order to fix the Z-fold of the airbag. The folded airbag is then introduced into a further apparatus with which it is drawn into an envelope, which is also designated as a stocking.

The problem (object) on which the present invention is based is to simplify the manufacture of airbag modules, with it being possible in particular to carry out the production of a defined airbag fold in as simple a manner as possible and with both the retention of the airbag fold and as simple a handling of the folded airbag as possible being ensured.

### SUMMARY OF THE INVENTION

This object is satisfied through the features of claim 1 relating to a folding apparatus and in particular in that the apparatus includes a folding chamber which tapers, starting at an entry region for an at least partly spread out airbag to be folded, in the direction of an exit region for the folded airbag and which includes inner sides which are mutually oppositely disposed in a configuration of use and which are each formed by a rib structure, the ribs of which form an exit nozzle which determines the airbag fold for the airbag moved through the folding chamber in the exit region of the folding chamber.

With the help of the apparatus in accordance with the invention, the airbag to be folded is automatically brought into the respective desired folding configuration when the initially at least partly spread out airbag is moved, for example is drawn, through the folding chamber. The ribs in the exit region of the folding chamber, which e.g. decreases in width or tapers, define the airbag fold, such that the airbag which emerges from the exit nozzle of the folding chamber has the desired fold and can be further processed directly afterwards in that the folded airbag is, for example, supplied to an enveloping device which is arranged directly after the folding chamber and whereby the folded airbag which comes from the exit chamber can be introduced directly into an envelope, which is also designated as a stocking, and which is dimensioned in accordance with the cross-section of the folded airbag. The apparatus in accordance with the invention can thus be provided in the form of a combined folding and stocking introduction apparatus.

Preferred embodiments are also recited in the subordinate claims, the description and the drawings.

The ribs preferably extend in a straight line, with it being possible in particular for it to be provided that at least some of the ribs extend from the entrance region to the exit region and thus over the entire length of the folding chamber.

Furthermore, it is proposed in accordance with the invention for a plurality of ribs, and in particular all ribs, to extend up to and into the exit region, so that the ribs run toward one another in the direction of the exit region as a result of the tapering of the folding chamber.

The rib density can be greater in the exit region than in the entry region viewed perpendicular to the direction of movement of the airbag.

In particular the rib structures are each fan-shaped.

In order to facilitate the introduction of the airbag to be folded into the folding chamber, the entry region can have a, for example, gap-like or slit-like introduction opening for the airbag between the rib structures which extends over the entire width of the folding chamber.

The folding chamber or the rib structures are preferably formed such that the airbag fold ultimately defined by the exit nozzle defined by the ribs is a Z-fold. In particular the folding chamber can be designed such that the airbag to be folded “snakes its way” or “slithers” between the ribs in the manner of a meander at least at the exit region of the folding chamber.

The rib structures can be mutually offset in particular such that a recess or “valley” is in each case oppositely disposed to an elevation or “peak”.

In a further preferred exemplary embodiment of the invention the rib structures lie opposite to one another without overlapping. An engaging into one another or a dovetailing of the mutually oppositely disposed rib structures thus does not take place in this process.

Alternatively, provision can be made for the rib structures to engage into one another or to dovetail, mesh or interleave with one another at least in the exit region of the folding chamber.

The height of at least some of the ribs can increase in the direction of the exit region.

Furthermore, it is proposed in accordance with the invention for the ribs to have the same height in at least one of the rib structures in each cross-sectional plane extending perpendicular to the direction of movement of the airbag.

Alternatively, provision can be made that the ribs have a different height at least in the exit region.

In a particularly preferred exemplary embodiment of the invention, a plurality of ribs is provided in each of the two mutually oppositely disposed rib structures, the ribs extending from the entry region of the folding chamber up to their exit region and arranged in fan-shape such that, starting from the entry region, the width of each rib decreases in the direction of the exit region to the benefit of its height, whereby the airbag envelope, which still lies at least approximately flat in the entry region, is set up more and more during its movement through the folding chamber in the direction of the exit region until the corresponding airbag fold is present at the exit nozzle of the folding chamber formed by the ribs. In this arrangement, provision can in particular be made for the height of the ribs to increase continuously, i.e. for the ribs to extend ramp-like so to speak.

It is not absolutely necessary in accordance with the invention for the ribs to be continuous elevations in the longitudinal direction. Instead of continuous ribs, rib-like structures in the form of a plurality of discrete elevations arranged one after the other can in principle also be provided, with structures of this kind also being ribs in the sense of the present application.

In accordance with the invention, the rib structures can be formed at separate folding inserts or as separate folding inserts which can be inserted into a holder or a carrier to form the folding chamber.

A plurality of folding inserts can be provided which differ from one another with respect to their rib structure, in particular with respect to the height profile of the ribs which extends perpendicular to the direction of movement of the airbag.

In this way a single folding apparatus can be used for the production of different airbag folds in that the corresponding folding inserts are simply selected and are applied to the holders or carriers of the folding chamber which are provided for the folding inserts.

An enveloping device can be arranged after the folding chamber whereby the folded airbag which comes from the exit nozzle can be introduced directly into an envelope dimensioned in accordance with the cross-section of the folded airbag and which fixes the folded state of the airbag.

An advantageous method, which can in particular be carried out with a folding apparatus in accordance with the invention for folding airbags for motor vehicles, is characterized in accordance with the independent method claim 18 in that an at least partly spread out airbag to be folded is moved through a folding chamber which tapers, starting at an entry region for the airbag to be folded, in the direction of an exit region for the folded airbag which comprises inner sides which are mutually oppositely disposed in a configuration of use and which are formed in each case by a rib structure, the ribs of which form an exit nozzle in the exit region of the folding chamber which determines the folding of the airbag for the airbag which is moved through the folding chamber.

In this method, the folded airbag which comes out of the exit chamber in an enveloping device which is placed after the folding chamber can preferably be introduced directly into an envelope which is dimensioned in accordance with the cross-section of the folded airbag and which fixes the folded state of the airbag.

### BRIEF DESCRIPTION OF THE DRAWINGS

The invention will be explained in the following in an exemplary manner with reference to the drawing. There are shown:

FIG. 1 is an embodiment of a folding apparatus in accordance with the invention in the opened state with a spread out airbag to be folded,

FIG. 2 is the folding apparatus of FIG. 1 in the closed state with a folded airbag,

FIG. 3 is a plan view of the opened folding apparatus of FIG. 1 with a cross-sectional view in the entry region and a further, supplemented cross-sectional view in the exit region of the folding apparatus, and

FIGS. 4 through 7 show various further views of the folding apparatus of FIG. 1.

### DESCRIPTION OF THE PREFERRED EMBODIMENT

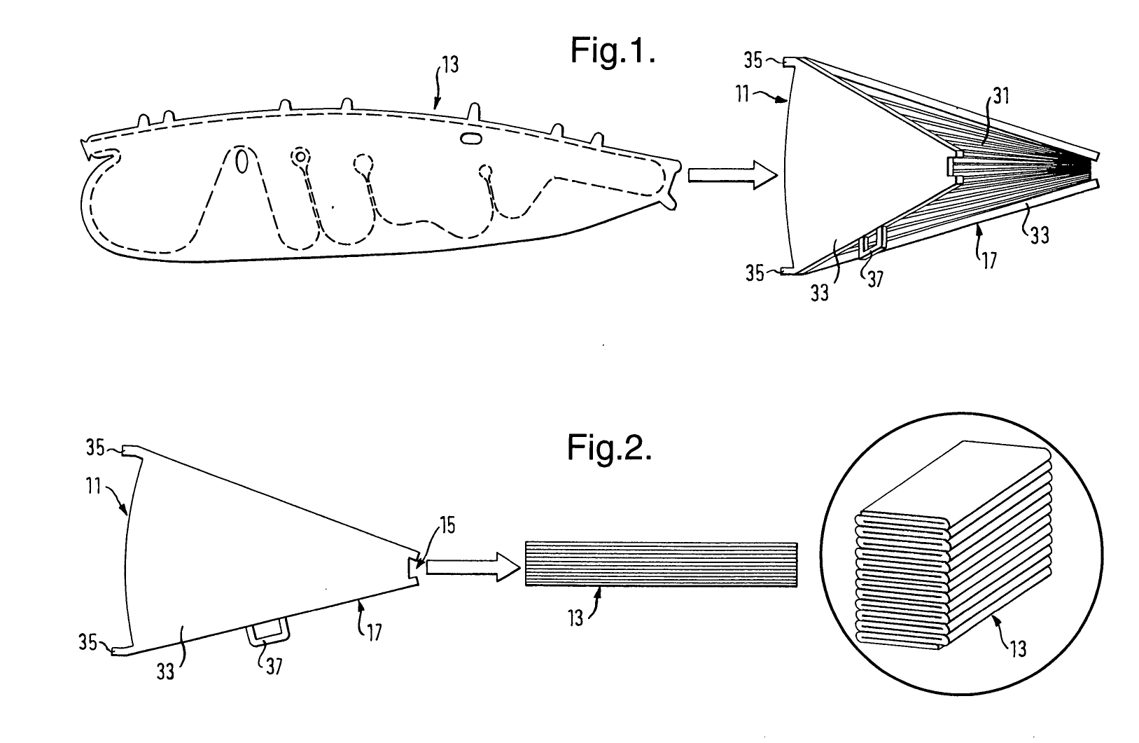

The folding apparatus in accordance with the invention illustrated in the opened state in FIG. 1 includes two circular-sector-shaped carriers 33 which are connected to one another in an articulated manner. The articulated connection of the two carriers 33 takes place through two hinge sections 35 which are laterally outwardly disposed on the broader side of the apparatus which forms an entry region 11 for the airbag 13 to be folded. The upper carrier 33 in FIG. 1 is provided with a handle 37 in order to open and close the folding apparatus.

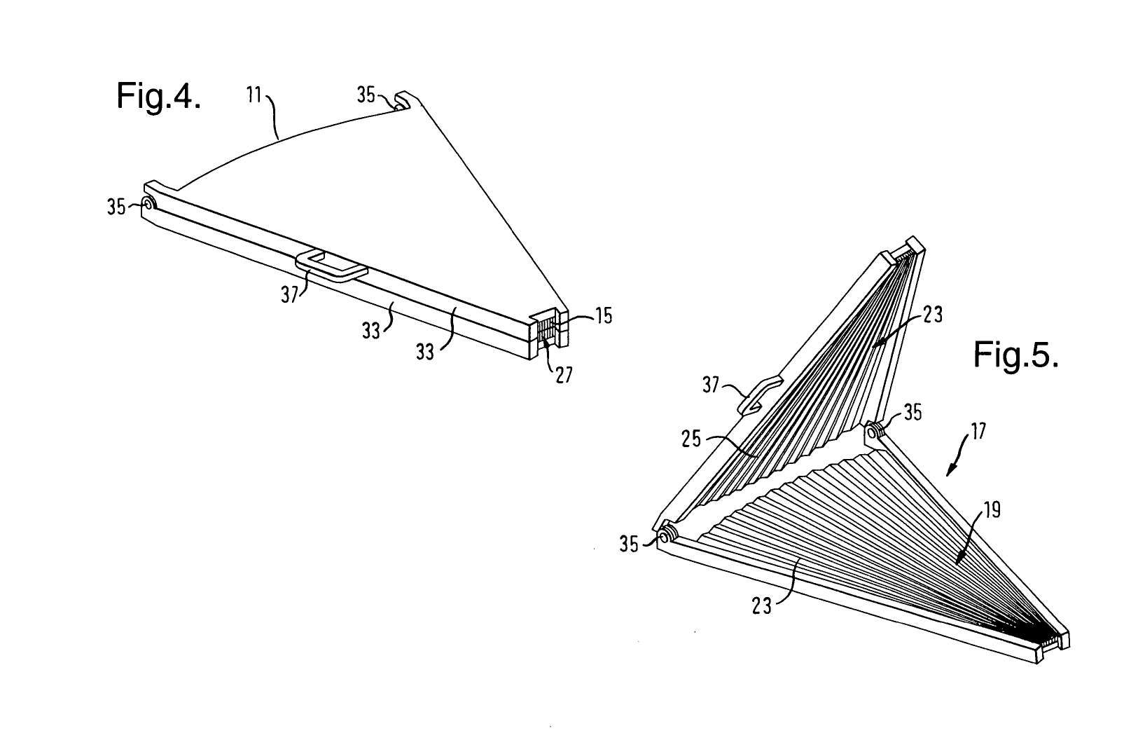

The carriers 33 serve for the reception and holding of fan-shaped folding inserts 31, of which only the folding insert 31 associated with the lower carrier 33 is shown in FIG. 1. The construction of the folding inserts 31 will be discussed in more detail in the following in particular in connection with FIG. 3.

The airbag 13 illustrated in the spread out state in FIG. 1 is the airbag of a roof rail airbag arrangement. This airbag 13, however, represents only an example for an airbag to be folded by means of the folding apparatus in accordance with the invention. In principle, airbags of any desired design can be folded by means of the folding apparatus in accordance with the invention.

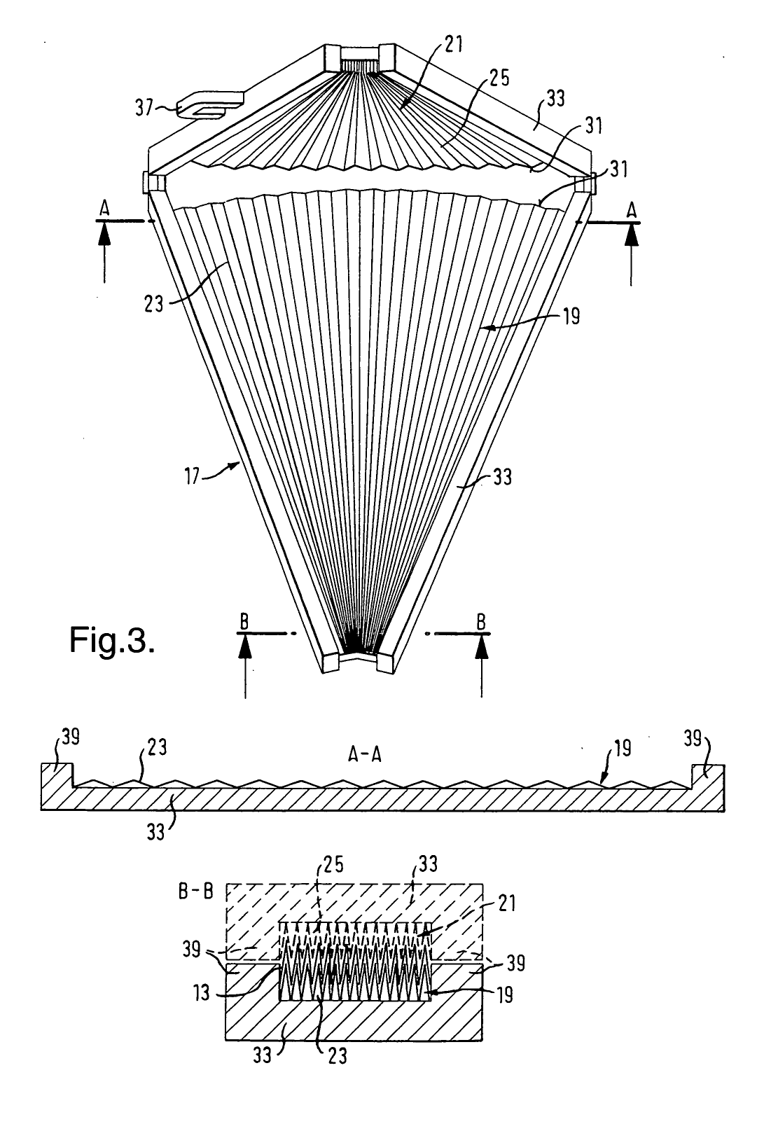

FIG. 2 shows the folding apparatus in the closed state, in which the carriers 33 are in their configuration of use and define a folding chamber 17 which in this exemplary embodiment is laterally closed, is open at the front entry region 11 as well as at a rear exit region 15, which will be explained in more detail in the following, and is bounded at the two other mutually oppositely disposed inner sides by the folding inserts 31 which are applied to the carriers 33.

Through the structure of the folding inserts 31 which is described in the following, the folding chamber 17 is formed such that the airbag 13 is folded by itself, so to speak, by being passed through the folding chamber 17 to form a long stretched package which, in the embodiment of the folding inserts 31 which is described here, has a homogeneous Z-fold such as in particular the enlarged illustration of the folded airbag 13 at the far right in FIG. 2 shows.

FIG. 3 shows the fan-shaped structure of the folding inserts 31, each of which has a rib structure 19, 21 consisting of ribs 23, 25 which extend from the entry region 11 up to the exit region 15 of the folding chamber 17 and which decrease in their width to the benefit of their height from the entry region 11 to the exit region 15 as a result of the tapering folding chamber 17. This can be clearly recognized in the example of the rib structure 19 of the lower folding insert 31 in FIG. 3 through the cross-sectional illustrations A-A at the entry region 11 and B-B at the exit region 15 which are enlarged to different degrees.

These illustrations also show that the ribs 23 have a lesser height at the entry region 11 than the side walls 39 of the carrier 33. At the exit region 15, in contrast, the height of the ribs 23 corresponds approximately to the height of the side walls 39. Therefore a gap-like introduction opening 29 is present between the folding inserts 31 in the entry region 11 when the folding chamber 17 is closed (cf. FIG. 6), whereas either no or at most a small intermediate space is present at the exit region 15 between the ribs 23, 25, i.e. the rib structures 19, 21 are also disposed opposite to one another without overlapping at the exit region 15.

An engaging in one another or a dovetailing between the ribs 23 of the lower carrier 33 and the ribs 25 of the upper carrier 33 thus does not take place in this exemplary embodiment. In principle, this would, however, be possible at least at the exit region 15.

The rib structure 19 of the lower carrier 33 and the rib structure 21 of the upper carrier 33 are mutually offset in such a manner that when the folding chamber 17 is closed, in each case an elevation of the one rib structure 19, 21 is oppositely disposed to a recess of the other rib structure 21, 19, i.e. in each case a “peak” is disposed opposite a “valley”. S meander-shaped course of the airbag 13 between the ribs 23, 25 thereby results at the exit region 15—when considered in cross-section and over the width of the folding chamber 17. This is shown by the completion of the corresponding cross-sectional view B-B in FIG. 3 which is partly illustrated in broken lines.

At the exit region 15 of the folding chamber 17 the structure which is formed by the ribs 23, 25 can therefore be designated as an exit nozzle 27 of the folding chamber 17, whereby the manner of the airbag folding is uniquely determined. Airbag folds which deviate from the homogeneous Z-fold in accordance with FIG. 2 can be achieved through correspondingly modified nozzles 27 or rib structures 19, 21 respectively. Thus, for example, in deviation from the illustrated embodiment, the ribs 23, 25 can have a different height in each cross-sectional plane or at least at the exit region 15. Furthermore, a deviation can be made from the continuous increase in the rib height in the direction of the exit region 15 at the expense of the rib width.

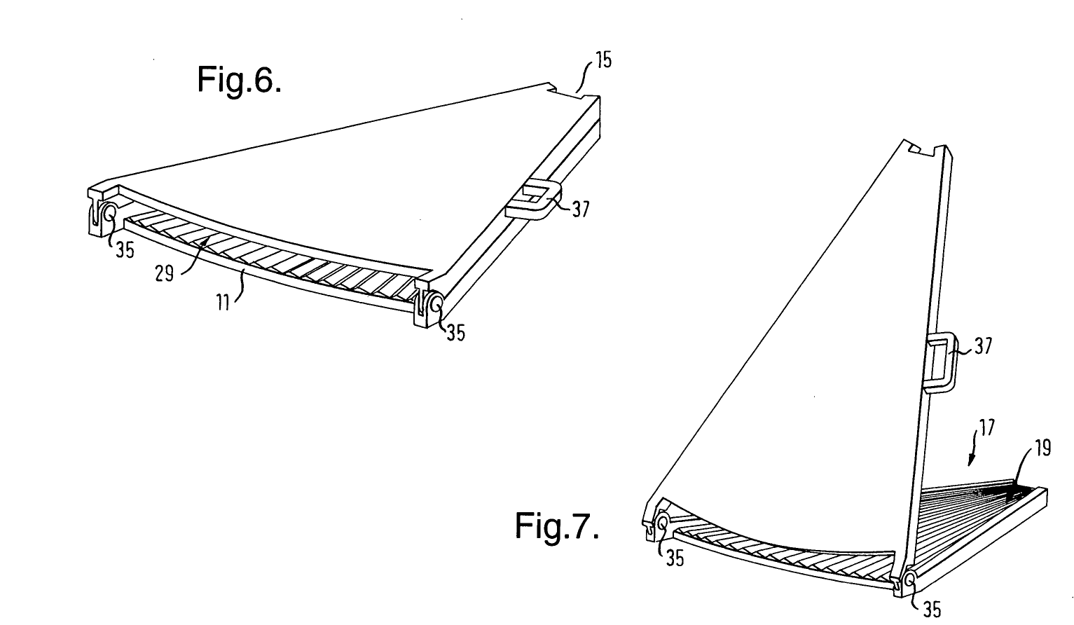

In the illustrations of the folding apparatus in accordance with the invention in FIGS. 4-7, FIG. 6 shows in particular the already mentioned slit-shaped introduction opening 29 of the folding chamber 17, whereas FIG. 4 shows the exit nozzle 27 of the exit region 15 which has a significantly smaller width in comparison with the introduction opening 29, with the apparatus being illustrated in each case with open folding chamber 17 in FIGS. 5 and 7.

In the exemplary embodiment of the folding apparatus in accordance with the invention illustrated here, the introduction of the airbag to be folded 13 (cf. FIG. 1) takes place via the introduction opening 29 which is located at the entry region 11 when the folding chamber 17 is open in order to be able to grip the front end of the airbag 13 for pulling it through the folding chamber 17.

Alternatively, the folding chamber 17 can be designed to be open at least at one side, whereby it is e.g. made possible to fold an airbag 13, which is already provided with a lance which serves as a gas distribution tube, in that an edge region of the airbag 13 which is provided with a lance is led outside the folding chamber 17 along the latter and is held in the process at this outwardly disposed edge region.

The folding of an airbag 13 already provided with a lance can, however, also take place in accordance with the invention with a laterally closed folding chamber 17. For this purpose, the folding chamber 17 can be designed to be matched to the lance at the corresponding inner side and e.g. be provided with a suitably formed groove or channel in which the lance runs through the folding chamber 17 when the airbag 13 is led through the folding chamber 17.

Provision can, however, also be made in accordance with the invention for the airbag 13 to be folded without the lance and for the lance to be connected to the airbag 13 only after the folding process, i.e. after the emergence of the folded airbag 13 from the folding chamber 17.

The comparatively slightly corrugated envelope of the of the airbag 13, which still lies relatively flat on the lower rib structure 19 at the edge region 11 (cf. the cross-sectional illustration A-A in FIG. 3) is set up increasingly in the manner of a meander in its movement through the folding chamber 17 in accordance with the changing shape of the ribs 23, 25 and leaves the folding chamber 17 via the exit nozzle 27 as the airbag package having the homogeneous Z-fold which is illustrated in FIG. 2.

On emerging from the folding nozzle 27, this airbag package is directly introduced by means of a non-illustrated enveloping section, which directly adjoins the illustrated folding section, into an envelope, which is also designated as a stocking and which is drawn tautly over the airbag package in order to fix the folded state of the airbag 13 and thus to ensure a further handling without problem. The airbag 13 can then be stored, transported or integrated into an airbag module without the risk of an unfolding. Constructionally laborious and time consuming measures for heating and then cooling down the airbag are not required in the solution in accordance with the invention, whereby the folding of airbags and thus the manufacture of airbag modules can take place on the whole more rapidly and economically.

1. Apparatus for folding airbags for motor vehicles, having a folding chamber (17) which tapers, starting at an entry region (11) for an at least partly spread out airbag (13) to be folded, in the direction of an exit region (15) for the airbag (13) and which includes inner sides which are mutually oppositely disposed in a configuration of use and which are each formed by a rib structure (19, 21), the ribs of which form in the exit region (15) of the folding chamber (17) an exit nozzle (27) which determines the airbag fold for the airbag (13) which is moved through the folding chamber (17).

2. Apparatus in accordance with claim 1, characterized in that the ribs (23, 25) extend in a straight line.

3. Apparatus in accordance with claim 1 or claim 2, characterized in that at least some ribs (23, 25) extend from the entry region (11) to the exit region (15).

4. Apparatus in accordance with at least one of the preceding claims characterized in that the ribs (23, 25) run towards one another in the direction of the exit region (15).

5. Apparatus in accordance with at least one of the preceding claims, characterized in that the rib density is greater perpendicular to the direction of movement of the airbag (13) in the exit region (15) than in the entry region (11).

6. Apparatus in accordance with at least one of the preceding claims, characterized in that the rib structures (19, 21) are each fan-shaped.

7. Apparatus in accordance with at least one of the preceding claims, characterized in that the entry region (11) has between the rib structures (19, 21) a gap-like or slit-like introduction opening (29) for the airbag (13) which extends over the entire width of the folding chamber (17).

8. Apparatus in accordance with at least one of the preceding claims, characterized in that the airbag fold is a Z-fold.

9. Apparatus in accordance with at least one of the preceding claims, characterized in that the rib structures (19, 21) are mutually offset.

10. Apparatus in accordance with at least one of the preceding claims, characterized in that the rib structures (19, 21) lie opposite one another without overlapping.

11. Apparatus in accordance with at least one of the preceding claims, characterized in that the height of at least some ribs (23, 25) increases in the direction of the exit region (15).

12. Apparatus in accordance with at least one of the preceding claims, characterized in that in at least one of the rib structures (19, 21) the ribs (23, 25) have the same height in each cross-sectional plane which extends perpendicularly to the movement direction of the airbag (13).

13. Apparatus in accordance with any one of the claims 1 to 11, characterized in that the ribs (23, 25) have a different height at least in the exit region.

14. Apparatus in accordance with at least one of the preceding claims, characterized in that the rib structures (19, 21) are formed at separate folding inserts or as separate folding inserts (31) which can be inserted into a holder or a carrier (33) for forming the folding chamber (17).

15. Apparatus in accordance with claim 14, characterized in that a plurality of folding inserts (31) is provided which differ from one another in regard to their rib structure (19, 21), in particular in regard to the height profile of the ribs (23, 25) which extends perpendicular to the direction of movement of the airbag (13).

16. Apparatus in accordance with at least one of the preceding claims, characterized in that the folding chamber (17) is open at the side in the configuration of use.

17. Apparatus in accordance with at least one of the preceding claims, characterized in that an enveloping device is arranged after the folding chamber (17) whereby the folded airbag (13) which comes from the exit nozzle (27) can be introduced directly into an envelope which is dimensioned in accordance with the cross-section of the folded airbag and which fixes the folded state of the airbag (13).

18. Method for folding airbags for motor vehicles, in which an at least partly spread out airbag (13) to be folded is moved through a folding chamber (17) which tapers, starting at an entry region (11) for the airbag (13) to be folded, in the direction of an exit region (15) for the airbag (13) which comprises inner sides which are mutually oppositely disposed in a configuration of use and which are formed in each case by a rib structure (19, 21), the ribs of which form an exit nozzle (27) in the exit region (15) of the folding chamber (17) which determines the folding of the airbag for the airbag (13) which is moved through the folding chamber (17).

19. Method in accordance with claim 18, characterized in that the folded airbag (13) which comes out of the exit nozzle (27) is introduced into an enveloping device which is placed after the folding chamber (17) directly into an envelope which is dimensioned in accordance with the cross-section of the folded airbag and which fixes the folded state of the airbag (13).

20. Method in accordance with claim 18 or claim 19, characterized in that an apparatus in accordance with any one of the claims 1 to 17 is used.
